(19) United States
(12) Patent Application Publication
(10) Pub. No.: US 2015/0077449 A1
(43) Pub. Date: Mar. 19, 2015

(54) PRINTING APPARATUS AND PRINTING METHOD

(71) Applicant: SEIKO EPSON CORPORATION, Tokyo (JP)

(72) Inventor: Yutaka KOBASHI, Shiojiri (JP)

(21) Appl. No.: 14/473,172

(22) Filed: Aug. 29, 2014

(30) Foreign Application Priority Data
Sep. 19, 2013 (JP) 2013-194426

(51) Int. Cl. B41J 2/175; B41J 2/21

(52) U.S. Cl. CPC B41J 2/17566; B41J 2/21
USPC 347/7

(57) ABSTRACT

A printing apparatus includes a first processing section configured to convert input values that are specified for each pixel in image data into amounts of ink for inks of each color, and a second processing section configured to generate half tone data from the image data that is converted. The second processing section is further configured to convert an amount of ink for a first ink, which is in a range of a first amount of ink where it is easy for density unevenness to be generated, into an amount of ink for the first ink and an amount of ink for a second ink that is the same color as the first ink and has a high brightness compared to the first ink. An increase in the amount of the first ink that is set in the range of the first amount of ink is large.

### CROSS-REFERENCE TO RELATED APPLICATIONS

This application claims priority to Japanese Patent Application No. 2013-194426 filed on Sep. 19, 2013. The entire disclosure of Japanese Patent Application No. 2013-194426 is hereby incorporated herein by reference.

### BACKGROUND

1. Technical Field

The present invention relates to a printing apparatus and a printing method where half tone dots are formed.

2. Related Art

There is known a printing method where half tone dots are printed by landing ink. Here, half tone data is an image which is configured by points which are different in the number of screen lines, size, shape, or density. Half tone data is generated by dithering, error diffusion, or the like. Half tone dots are individual elements which configure gradations. Half tone dots may take various shapes, such as square shapes, circle shapes, and oval shapes. Half tone dots are referred to below simply as dots.

In addition, the image is an image which appropriately expresses the shape, color, and sense of perspective of an original, such as a photograph, painting, illustration, diagram, or character which are visible to the human eye. Image data has the meaning of digital data which expresses an image. Examples of data which corresponds to image data include vector data, bitmap images, and the like. Vector data refers to image data which is stored as a set of commands and parameters which express geometric shapes such as straight lines, circles, and arcs. A bitmap image is image data which is written by aligning pixels. Pixels are the smallest elements which configure an image where it is possible to independently assign color and brightness.

There are cases where a print substrate changes shape and a coverage ratio changes due to ink landing on the print substrate. Changes in the coverage ratio cause so-called density unevenness. The phenomenon where the print substrate changes shape due to the landing of the ink is described below as cockling. In addition, a phenomenon where density unevenness is generated due to the print substrate changing shape in this manner is described as cockling unevenness.

A technique is disclosed where density unevenness is suppressed by correcting the pixels where density unevenness is generated using a table for correction (see JP-A-2007-106066, for example).

### SUMMARY

Since deterioration in image quality which is caused by cockling is a problem which has been remarkable in recent years, effective solutions have not yet been proposed.

The present invention is conceived in light of the problem described above and has an advantage of effectively suppressing deterioration in image quality due to cockling.

In order to solve the problem described above, one aspect of the present invention is configured as a printing apparatus configured to discharge ink from a print head. The printing apparatus includes a first processing section configured to convert input values that are specified for each pixel in image data into amounts of ink for inks of each color, and a second processing section configured to generate half tone data that specifies the presence or absence of half tone dots based on the image data that is converted. The second processing section is further configured to convert an amount of ink for a first ink, which is in a range of a first amount of ink where it is easy for density unevenness to be generated, into an amount of ink for the first ink and an amount of ink for a second ink that is the same color as the first ink and has a high brightness compared to the first ink. An increase in the amount of the first ink that is set in the range of the first amount of ink is large compared to an increase in the amount of the first ink in a range of a second amount of ink that is different to the range of the first amount of ink.

That is, one aspect of the present invention relates to the printing apparatus discharges ink from the print head. The second processing section converts the amount of ink for the first ink in a range of the first amount of ink where it is easy for density unevenness to be generated into the first ink and the second ink that is the same color as the first ink and has a high brightness compared to the first ink. Here, the inks with the same color are inks that contain the same types of coloring materials or that express the same hues. In addition, the ink with a high brightness has the meaning of an ink with the same gradation values (amounts of ink) where the brightness is high compared to the first ink. For example, as an example of the second ink that is the same color and has high brightness, the second ink is light cyan ink in a case where the first ink is cyan ink. In addition to this, the same applies for magenta ink and light magenta ink and black ink and gray ink.

As a result, an increase in brightness due to the dots of the second ink is reduced even in a case where dots of the first ink cause density unevenness (cackling unevenness) due to cockling.

In addition, an increase in the amount of the first ink that is set in the range of the first amount of ink is large compared to an increase in the amount of the first ink in a range of the second amount of ink that is different to the range of the first amount of ink. The values of the amount of ink that is set according to the input values has a certain range (for example, 0 to 255). That is, in the range of the first amount of ink described above, the range of the input values that corresponds to the range of the first amount of ink decreases due to the increase in the amount of the first ink being large. Then, it is difficult to select the amount of ink for the first ink where it is easy for density unevenness to be generated according to the range of the input values being narrowed.

In addition, in an aspect of the present invention, the range of the first amount of ink is a range that corresponds to an amount of ink where a coverage ratio, which indicates an area covered by ink per unit area, is in a range of 75 percent to 95 percent.

In the aspect of the invention that is configured as described above, since the present invention is applied with regard to an amount of ink that corresponds to a coverage ratio of 75 percent to 95 percent, it is possible to apply a countermeasure for density unevenness in the present invention without significantly damaging the relationship characteristics of the colors between the input values and the amounts of ink for reproducing the input values.

Then, an aspect of the present invention may have a configuration where the second ink that is set in the range of the first amount of ink is reduced in accordance with an increase in the input values.

In the aspect of the invention that is configured as described above, it is possible for the sum of the amounts of ink in the range of the first amount of ink to be constant by reducing the second ink with regard to the increase in the first ink. As a result, it is possible to apply the present invention in a range that does not exceed an amount of ink that is able to be applied onto the print substrate, and it is possible to suppress density unevenness that is caused by cockling while suppressing bleeding of dots.

The technical concept of the present invention may be embodied using another object instead of being realized only in the form of the printing apparatus. In addition, it is also possible to be embodied as a method (a printing method) that is provided with steps that correspond to the characteristics of the printing apparatuses of any of the aspects described above, as a printing program that executes the method in predetermined hardware (a computer), and as a recording medium where the program is recorded and that is readable by a computer. In addition, the printing apparatus may be realized by a single apparatus, or may be realized by a combination of a plurality of apparatuses.

### BRIEF DESCRIPTION OF THE DRAWINGS

Referring now to the attached drawings which form a part of this original disclosure:

FIG. 1 schematically illustrates a hardware configuration and a software configuration according to the present embodiment;

FIGS. 2A, 2B, and 2C illustrate diagrams explaining a principle where density unevenness is generated due to cackling;

FIGS. 3A and 3B are diagrams for illustrating a coverage ratio using a single color;

FIG. 4 illustrates a relationship between a first ink which is set according to an input value and an amount of ink for a second ink;

FIGS. 5A, 5B, 5C, and 5D illustrate diagrams explaining a relationship between density unevenness and a coverage ratio;

FIG. 6 illustrates a print control process for printing an image using a flow chart;

FIGS. 7A and 7B illustrate diagrams for explaining a separation process;

FIG. 8 is a diagram illustrating a dot conversion table which is used by a half tone processing section 13c in step S4;

FIGS. 9A and 9B illustrate diagrams explaining designated image data which is converted using the processes of steps S3 and S4;

FIGS. 10A, 10B, and 10C illustrate diagrams for explaining dots which are generated in the present application; and

FIGS. 11A and 11B illustrate diagrams explaining a separation process according to a second embodiment.

### DETAILED DESCRIPTION OF EMBODIMENTS

Below, selected embodiments will be described in the following sequence.
1. First Embodiment
   1.1. Configuration of Print Control Apparatus
   1.2. Printing Method
2. Second Embodiment
3. Various Modified Examples

### 1. First Embodiment

### 1.1. Configuration of Print Control Apparatus

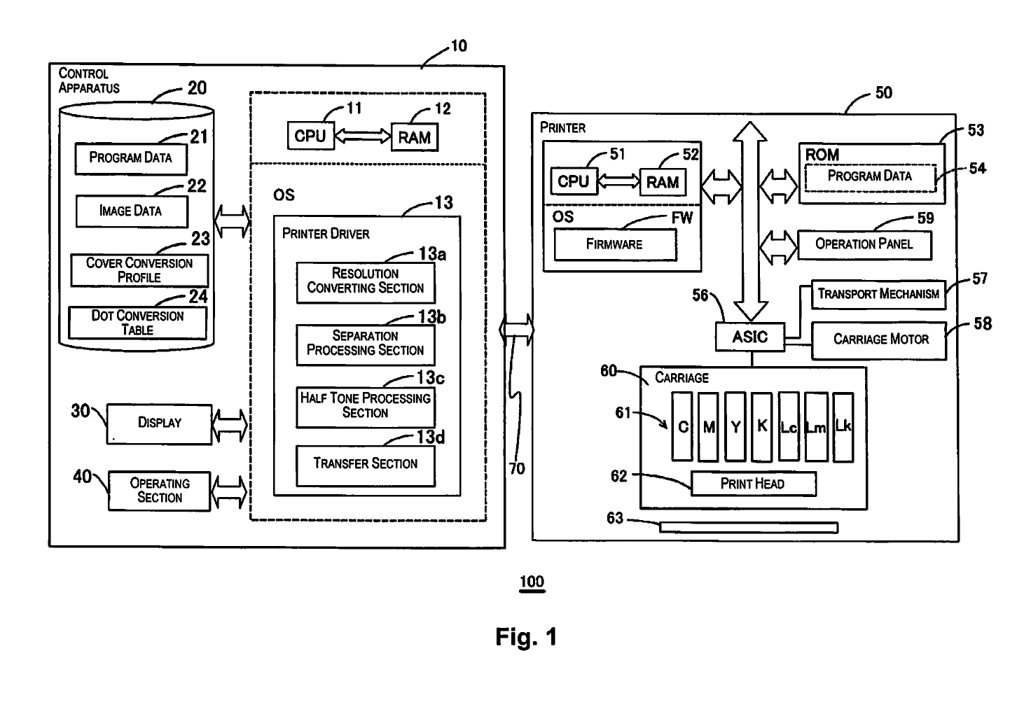

FIG. 1 schematically illustrates a hardware configuration and a software configuration according to the illustrated embodiment. FIG. 1 illustrates a control apparatus 10 and a printer 50. The control apparatus 10 has a function of executing printing in the printer 50 by controlling the printer 50 and corresponds to, for example, a personal computer (a PC), a server, a mobile terminal apparatus, or the like. The printer 50 is an output apparatus (JIS X0012-1990) which creates a hard copy recording of data with rows of discrete graphic characters, which belong to one or a plurality of character collections which are determined in advance, as the main format. In many cases, it is also possible to use the printer as a plotter. A plotter is an output apparatus (JIS X0012-1990) which directly produces a hard copy recording of data in the format of two-dimensional graphics on a medium which is able to be removed. It is sufficient if the printer 50 is able to function as a printer, and the printer 50 may be a so-called multifunction device which also functions as a scanner or a copier.

In the illustrated embodiment, a system which is formed of the control apparatus 10 and the printer 50 is regarded as the printing apparatus. In addition, it is not assumed that the control apparatus 10 and the printer 50 are only apparatuses which are each independent. The control apparatus 10 and the printer 50 may correspond to each section inside one product which is configured integrally and a configuration where a portion of the product functions as a printing apparatus 100 is also included in the illustrated embodiment.

In the control apparatus 10, a printer driver 13 for controlling the printer 50 is executed by a CPU 11 running program data 21, which is stored in a hard disk drive (HDD) 20 or the like, in a RAM 12 and performing calculation in accordance with the program data 21 in an OS. The printer driver 13 executes each of the functions of a resolution converting section 13a, a separation processing section (a first processing section) 13b, a half tone processing section (a second processing section) 13c, a transfer section 13d, and the like in the CPU 11. Each of these functions will be described later. In addition, in a case where the control apparatus 10 and the printer 50 are configured integrally as the printer, the printer driver 13 and the HDD 20 may be respectively configured as firmware FW and as a ROM 53 or the like which will be described later.

A display 30 which is a display section is connected with the control apparatus 10 and user interface (UI) screens which are necessary for each of the processes are displayed on the display 30. In addition, the control apparatus 10 is appropriately provided with an operation section 40 which is realized by, for example, a keyboard, a mouse, various types of buttons, a touch pad, a touch panel, or the like and instructions which are necessary for each of the processes are input via the operation section 40 by a user. Here, the display 30 and the operation section 40 may be incorporated into the control apparatus 10 or may be externally connected. The control apparatus 10 is connected with the printer 50 by a network 70 so as to be able to communicate with the printer 50. The network 70 is a generic term for a wired or wireless communication path. In a case where the control apparatus 10 and the printer 50 are an integral product as described above, the network 70 is a communication path inside the product. As will be described later, half tone data is generated in the control apparatus 10 using the function of the printer driver 13 and the half tone data is transmitted to the printer 50 via the network 70.

The printer 50 is a serial printer where a print head 62 moves along a scanning axis direction. The serial printer is a printing apparatus (JIS X0012-1990) which prints one character at a time.

In the printer 50, the firmware FW for controlling the apparatus itself is executed by a CPU 51 running program data 54, which is stored in a memory such as the ROM 53, in the RAM 52 and performing calculation in accordance with program data 54 in an OS. The firmware FW generates print data by appropriately executing interpretation of commands or decompression or the like of compressed data based on PDL data which is transmitted from the control apparatus 10. Then, it is possible to execute printing based on the print data by sending the print data to an ASCI 56.

The printer 50 is further provided with an operation panel 59. The operation panel 59 includes a display section (for example, a liquid crystal panel), a touch panel which is formed inside the display section, and various types of buttons or keys, and the operation panel 59 receives input from the user and displays the necessary UI screens on the display section.

The ASIC 56 acquires the print data and generates driving signals for driving, for example, a transport mechanism 57, a carriage motor 58, and the print head 62 based on the print data. The print head 62 corresponds to a permanent head and is a mechanical section or an electrical section (JIS Z8123-1:2013) of a printer body which continuously or intermittently generates liquid droplets of ink. The printer 50 is provided with, for example, a carriage 60 and the carriage 60 is mounted with cartridges 61 for each of a plurality of types of ink. In the example of FIG. 1, the cartridges 61 are mounted so as to correspond to various types of liquids which are, for example, cyan (C), magenta (M), yellow (Y), black (K), light cyan (Lc), light magenta (Lm), and gray (Lk). However, the specific type and number of inks which are used by the printer 50 are not limited to the inks described above and, for example, it is possible to use various inks such as orange, green, light gray, white, or metallic inks. In addition, the cartridges 61 may be installed at predetermined positions inside the printer 50 without being mounted on the carriage 60 and the cartridges 61 may take the form of an ink tank, an ink package, or the like.

The carriage 60 is provided with the print head 62 which ejects (discharges) ink which is supplied from each of the cartridges 61 from numerous ink discharge holes (below, nozzles). Accordingly, the printer 50 corresponds to an ink jet printer. The ink jet printer is a non-impact printing apparatus (JIS X0012-1990) where characters are formed by ejecting particles or small droplets of ink onto a sheet.

Piezoelectric elements for ejecting ink droplets (dots) from the nozzles are provided inside the print head 62 to correspond to each of the nozzles. The piezoelectric elements change shape when the driving signal is applied and discharge dots from the corresponding nozzles.

The transport mechanism 57 is provided with a paper feeding motor and a paper feeding roller which are not shown in the diagram and the print substrate is transported along a feed direction by driving control being carried out by the ASIC 56. The feed direction is the orientation of a geometric vector according to movement of the print substrate when the print substrate and the head face each other. In addition, the scanning direction is a direction which intersects with regard to the feed direction.

The print substrate is a material which holds a printed image. The shape of the print substrate is typically a rectangular shape, but there are circular shapes (for example, an optical disc such as a CD-ROM or a DVD), a triangular shape, a square shape, a polygon shape, and the like, and the shapes include at least all of the types of paper and paperboard products and processed products which are described in Japanese Industrial Standards “JIS P 0001: 1998 Paper, Board and Pulp—Vocabulary”.

By the ASIC 56 controlling driving of the carriage motor 58, the carriage 60 (and the print head 62) moves along the direction (the scanning direction) which intersects with the feed direction and the ASIC 56 discharges ink from each of the nozzles using the print head 62 in accordance with the movement of the carriage 60. Due to this, dots are attached to the print substrate and an image is reproduced on the print substrate based on the print data. Here, “intersecting” has the meaning of being orthogonal. However, orthogonal in the present specification does not have the meaning only of a strict angle of 90°, but has a meaning which includes errors in the angle to an extent which is permissible in terms of the quality of the product.

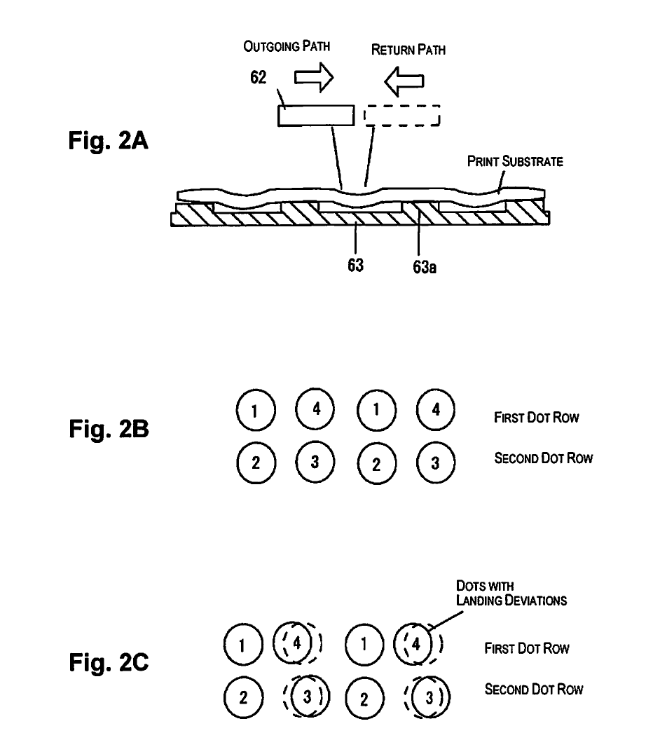

FIGS. 2A, 2B, and 2C illustrate diagrams explaining a principle where density unevenness is generated due to cockling. FIG. 2A illustrates the print substrate which is supported by a platen 63 in the printer 50. In addition, FIG. 2B illustrates dots which are printed on a region on the print substrate which faces the platen 63. Then, FIG. 2C illustrates dots which are printed on a region of the print substrate which faces between the platen 63.

As shown in FIG. 2A, the print head 62 adopts so-called multi-pass printing where printing is carried out by dividing the dots which are aligned in the direction of the scanning axis into an outgoing path and a return path of the back and forth movement in the scanning direction. FIGS. 2B and 2C give numbers from 1 to 4, which indicate the respective scan numbers, to dots which are printed in first to fourth scans.

As a result, odd numbered dots of a first dot row are printed in the first scan (the outgoing path) and odd numbered dots of a second dot row are printed in the second scan (the return path) as shown in FIGS. 2B and 2C. Next, after the print substrate is moved in the feed direction, even numbered dots of the first dot row are printed using a different nozzle in the third scan (the outgoing path). Then, even numbered dots of the second dot row are printed in the fourth scan (the returning path).

That is, the feeding of the sheet and the scanning of the print head 62 are performed alternately and dots are printed on the print substrate.

At this time, dots are generated by the ink which is discharged from the print head 62 landing on the print substrate and the ink being absorbed by an absorbing layer in the print substrate. In addition, stretching in the print substrate is caused by the absorbing layer absorbing the ink. However, the print substrate is supported using ribs 63a of the platen 63 as shown in FIG. 2A and is pinched by rollers of the transport mechanism 57 at an inner section of the transport path which is not shown in the diagram. As a result, there is less stretching of the print substrate in the regions which face the ribs 63a and there is more stretching in the regions which face between the ribs 63a. As a result, the print substrate changes shape so as to have a convex shape at the lower side between the ribs 63a. The time which is required until the ink which is discharged from the print head 62 lands on the print substrate changes when the shape of the print substrate changes.

In addition, since the print head 62 prints dots while moving back and forth in the scanning direction as described above, differences in the landing times cause landing deviations in the dots. In FIG. 2C, landing deviations occur in the dots of the first dot row which are printed in the fourth scan and the dots of the second dot row which are printed in the third scan. The dot landing deviations change the coverage ratio of the dots and are a factor in deterioration of image quality.

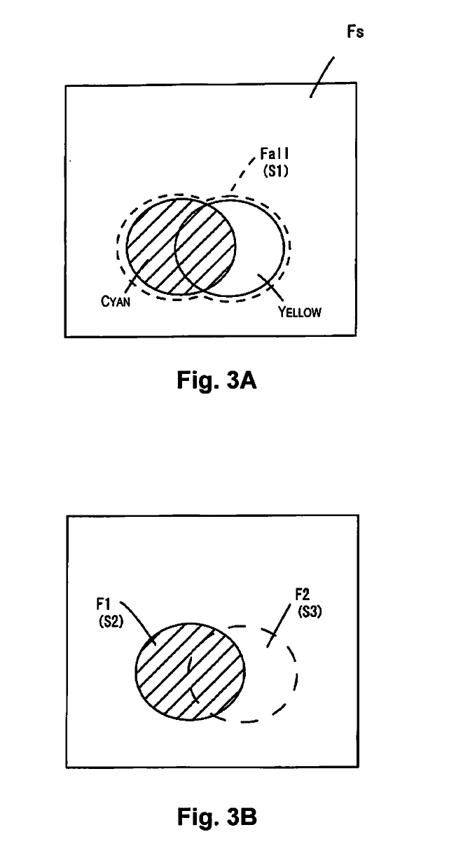

FIGS. 3A and 3B illustrate diagrams for explaining a coverage ratio using a single color. The coverage ratio illustrates a ratio of the area which is taken up by ink (dots) of one color in the unit area. In FIG. 3A, the unit area is set as Fs, and the entire region of two dots (cyan and yellow) which proportionally overlap is set as Fall. In a case of determining the coverage ratio of the ink for one color, firstly, the unit area Fs which includes the collection of dots shown in FIG. 3A is imaged and the image data is acquired. Next, the image data which is acquired is converted into a gray image. In order to simplify the description, the gray image is described as data where the highest brightness (white) is set as 0 and the lowest brightness (black) is set as 255. Next, binarization is performed with regard to the gray image after conversion and the ratio of the unit area Fs with regard to the entire region Fall (the coverage ratio) is determined. In detail, the gray image is binarized and the region where the dots are formed (that is, Fall) and the background region where the dots are not formed are isolated. Then, the number of pixels, which is equivalent to the entire region Fall which is isolated, is converted to a histogram and the area (an average value X) is calculated. Then, a coverage ratio S1 of the entire region Fall is obtained by dividing the area which is obtained (the average value X) by the unit area Fs.

Next, the entire region Fall of the dots which are included in the gray image is binarized using a threshold (brightness) where it is possible to distinguish yellow and cyan and a region F1 which is a cyan dot is isolated as shown in FIG. 3B. Then, the isolated area (the average value) of the region F1 which is a cyan dot is calculated. The method for calculating the area (the average value) of the region F1 which is a cyan dot is the same as that for the entire region Fall. Then, the coverage ratio S2 is obtained by dividing the area (the average value) of the region F1 which is a cyan dot by the unit area Fs. In addition, a coverage ratio S3 for yellow is determined by subtracting the coverage ratio S2 of the cyan dots from the coverage ratio S1 of the entire region Fall.

In the present application, in a range of an amount of ink where it is easy for density unevenness (cockling unevenness) to be generated using a single color of ink, density unevenness which is caused by cockling is reduced by generating dots of other colors near dots of this color. In the first embodiment, density unevenness is generated at a position where the first ink and the second ink, which is the same color as the first ink and has a high brightness compared to the first ink, are near to each other. For example, the second ink is light cyan in a case where the first ink is cyan. In addition, the second ink is light magenta in a case where the first ink is magenta. Then, the second ink is gray in a case where the first ink is black. As a result, the second ink suppresses an increase in brightness at positions where cockling unevenness of the first ink occurs even in a case where cockling is generated and cockling unevenness occurs in the dots of the first ink.

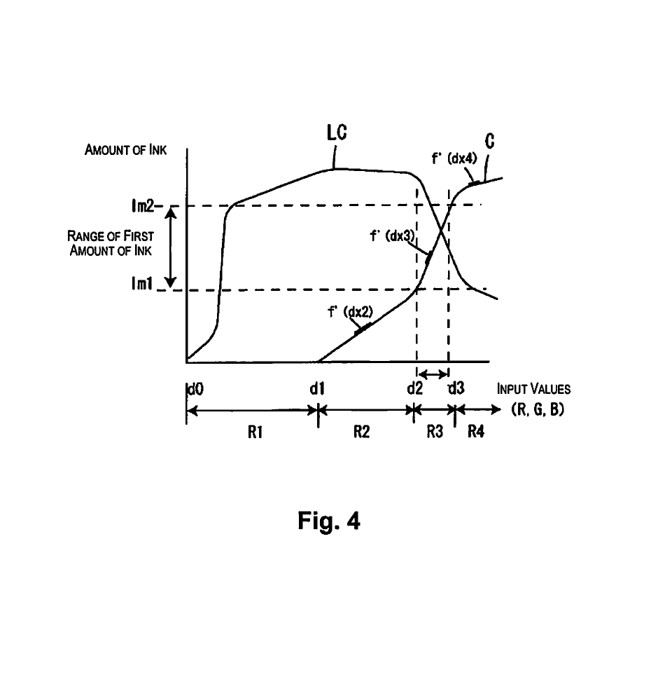

FIG. 4 illustrates a relationship between the first ink which is set according to an input value and an amount of ink for the second ink. The horizontal axis is input values (for example, each of the values of R, G, and B) which are designated by the image data and the vertical axis is the amount of ink. The input values and the amount of ink both take values of 0 to 255. FIG. 4 is a diagram where only the relationship characteristics are extracted in a case where, out of cyan, magenta, yellow, black, light cyan, light magenta, and gray which are associated with the input values, cyan is set as the first ink and light cyan is set as the second ink.

In FIG. 4, when the input values are in a first range R1 (a range from d0 to d1), only light cyan (Lc) is generated. In the first range, the amount of ink for light cyan also increases in accordance with an increase in the input values. Next, when the input values are in a second range R2 (d1 to d2), a third range R3 (d2 to d3), and a fourth range R4 (d3 to d4), an amount of ink for cyan (C) is generated in addition to light cyan (Lc).

When the input values are in the third range R3 to the fourth range R4, the amount of ink for cyan (C) increases but the amount of ink for light cyan (Lc) is reduced in accordance with an increase in the input values. This is because cockling unevenness is suppressed while suppressing bleeding of the dots by reducing the second ink with regard to the increase in the first ink so as not to exceed an amount of ink which is able to be applied onto the print substrate.

When the input values are in the third range R3 (d2 to d3), the amount of an increase in the amount of ink for cyan (C) is highest compared to the other ranges. In FIG. 4, the gradient f′(dx3) in the graph is high compared to the gradient (f′(dx2), f′(dx4)) in the graphs of the other ranges. Here, f′(dx) is a differential value in a graph illustrating the relationship between the input values and the amount of ink for cyan (C). In addition, dx2, dx3, and dx4 respectively express the input values in the second to fourth ranges. The third range R3 corresponds to a range (Im1 to Im2) of an amount of ink where it is easy for density unevenness to be generated. Since the amount of an increase in the amount of ink in the third range R3 (f′(dx3)) is high compared to other ranges, the range of the input values which corresponds to the third range R3 is narrow compared to the other ranges and it is difficult to select the amount of ink for the first ink where it is easy for density unevenness to be generated. As a result, the range of the amount of ink which corresponds to the third range R3 is the range of the first amount of ink in the present application where it is easy for density unevenness to be generated. In addition, the range of the amount of ink other than the third range R3 is the range of the second amount of ink.

In the illustrated embodiment, with a single color of ink, the amount of ink where it is easy for density unevenness to be generated is an amount of ink where the coverage ratio is 30 percent to 95 percent using the single color of dots and is preferably an amount of ink where the coverage ratio is 75 percent to 95 percent.

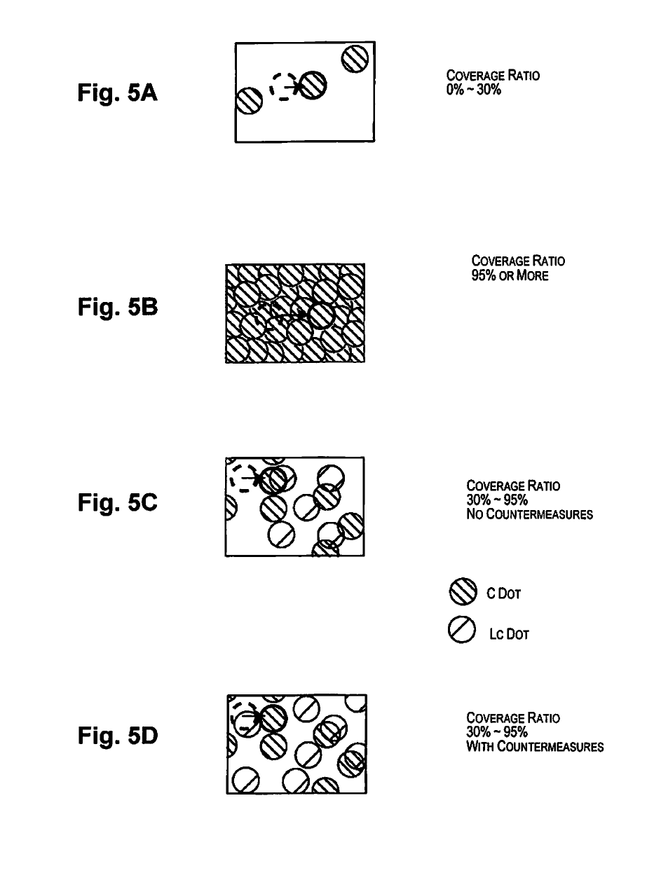

FIGS. 5A, 5B, 5C, and 5D illustrate diagrams explaining the relationship between the density unevenness and the coverage ratio. FIG. 5A illustrates dots in a case where the coverage ratio is 0 percent to 30 percent. When the coverage ratio is 0 percent to 30 percent, the dot arrangement is sparse and there are many arbitrary regions where dots in the single color are not formed. As a result, the coverage ratio does not change, or the amount of change in the coverage ratio is small and it is difficult for cockling unevenness to be generated even when landing deviations which are caused by cockling are generated in the dots.

FIG. 5B illustrates dots in a case where the coverage ratio is 95 percent or more. When the coverage ratio is 95 percent or more, the arrangement of the dots in the single color is dense, and there are few regions where the dots in the single color are not formed. As a result, the coverage ratio does not change, or the amount of change in the coverage ratio is small and it is difficult for cockling unevenness to be generated even when landing deviations which are caused by cockling are generated.

FIGS. 5C and 5D illustrate dots in a case where the coverage ratio is 30 percent to 95 percent. FIG. 5C illustrates an alignment of dots in the prior art. In addition, FIG. 5D illustrates an alignment of dots where a countermeasure for cockling unevenness is applied in the present application. The regions where the dots in the single color are aligned and the regions where the dots in the single color are not formed are appropriately mixed when the coverage ratio is 30 percent to 95 percent. As a result, when landing deviations which are caused by cockling are generated in the dots, the amount of change in the coverage ratio increases. That is, the range where it is easy for cockling unevenness to occur can be said to be when the coverage ratio is 30 percent to 95 percent.

In particular, in a range where the coverage ratio is 75 percent to 95 percent, the density of the first ink is sufficiently high, and the input values and the reproducibility of the colors with the dots are not significantly different even when the second ink is added. As a result, it is possible to suppress cockling unevenness in a range where the coverage ratio is 75 percent to 95 percent while minimizing deterioration in reproducibility of the colors using the inks.

As an example, the amount of ink for the second ink may be set to a range where the dots do not bleed. In detail, the amounts of the first ink and the second ink are specified in a range which does not exceed an upper limit value of the amount of dots applied per unit area which is set for the print substrate. It is obvious that the relationship characteristics of the first ink and the second ink are not limited to this.

### 1.2 Printing Method

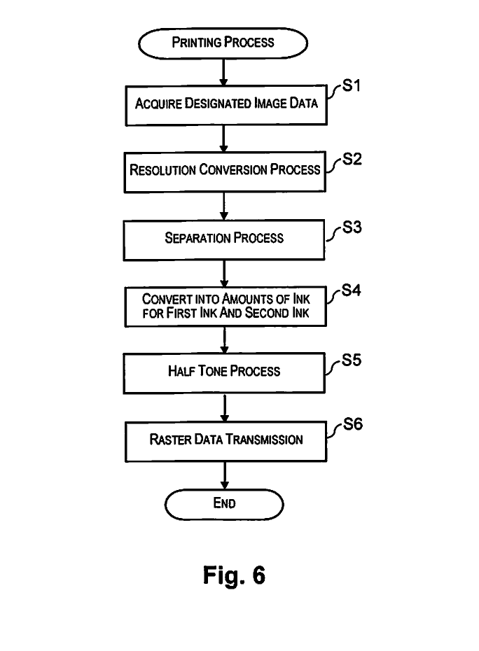

FIG. 6 illustrates a print control process for printing an image using a flow chart. Below, the printing method according to the illustrated embodiment will be described with a case where the first ink is cyan and the second ink is light cyan as an example. Here, although description thereof is omitted, the same configuration is possible even in a case where the first ink is magenta (M) and the second ink is light magenta (Lm) and a case where the first ink is black (K) and the second ink is gray (Lk).

In step S1, the control apparatus 10 acquires the image data when an image printing instruction is received from the user via the operation section 40. Below, image data which is the target of the printing process in the plurality of image data is also described as designated image data. The control apparatus 10 acquires the designated image data from an arbitrary information source such as an external device and records the designated image data in the HDD 20.

In addition to this, it is possible for the user to perform an image printing instruction by operating a mobile terminal or the like which is able to remotely operate the printer 50 from outside. In addition, it is possible for the user to give an instruction with regard to the printer 50 by combining various types of printing conditions such as the number of printing sections, the sheet size, and the printing resolution in the feed direction described above with the printing instruction.

In step S2, the resolution converting section 13a converts the resolution of the designated image data into a resolution which is able to be printed by the printer 50. For example, in a case where the resolution of the designated image data is 360 dpi×360 dpi and the printing resolution of the printer 50 is 1440 dpi×1080 dpi, the resolution converting section 13a converts the designated image data to a resolution of 1440 dpi×1080 dpi by magnifying single pixels in the designated image data by 12 (4×3).

Here, the number of pixels after resolution conversion which correspond to one pixel in the original designated image data is different depending on the quantization number in the half tone data which will be described later and various other factors.

In step S3, the separation processing section 13b performs a separation process with regard to the designated image data using a color conversion profile 23. As a result, according to the separation process, the input values (R, G, and 13) which are designated for each of the pixels in the designated image data are converted into amounts of ink (C, M, Y, and K) which are used by the printer 50.

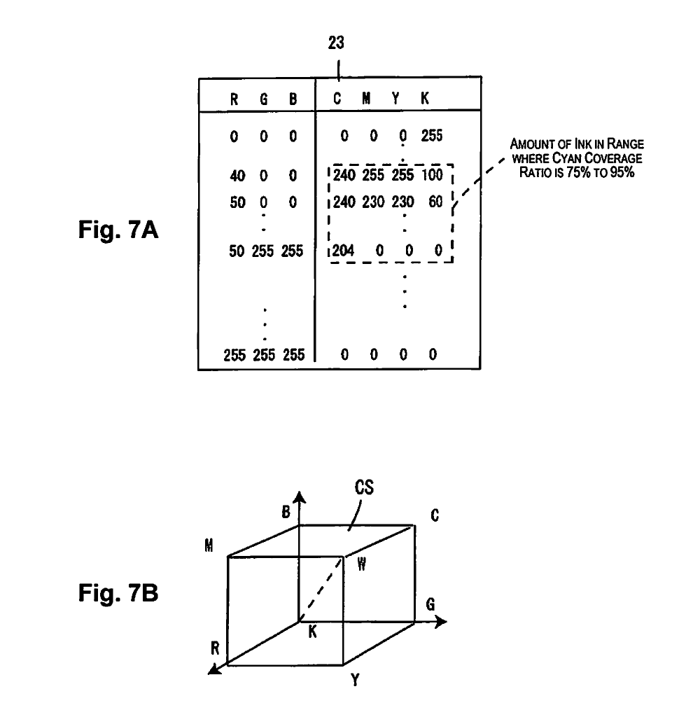

FIGS. 7A and 7B illustrate diagrams for explaining the separation process. FIG. 7A illustrates the color conversion profile 23 which is recorded in the HDD 20. The color conversion profile 23 is a table where values (the input values) of the image data in the color spaces (R, G, and B) are associated with amounts of ink (gradation values from 0 to 255) which correspond to the input values inside a gamut (a color range) which the printer 50 is able to reproduce.

FIG. 7B is a diagram explaining the gamut. A point W in a gamut CS is a point where (R, G, B)=(0, 0, 0). A point R is a point where (R, G, B)=(255, 0, 0). A point G is a point where (R, G, B)=(0, 255, 0). A point B is a point where (R, G, B)=(0, 0, 255). A point K is a point where (R, G, B)=(255, 255, 255). In addition, a point C is a point where (R, G, B)=(0, 255, 255). A point M is a point where (R, G, B)=(255, 0, 255). A point Y is a point where (R, G, B)=(255, 255, 0).

The data which is recorded in the color conversion profile 23 sets black (K) to (0, 0, 0) and associates each of the values of cyan (C), magenta (M), yellow (Y), and black (K) with the respective points in the gamut CS which are specified by each of the values of red (R), green (G), and blue (B). In detail, each of the values of RGB is converted into a value in a uniform color space CIELAB and is generated by being associated with the amount of ink which reproduces the value in the uniform color space CIELAB. In particular, an amount of increase in the amount of ink for the first ink (cyan) is the highest in the color conversion profile 23 compared to the other ranges when the input values are in a range of an amount of ink (the range of the first amount of ink) which corresponds to the third range R3 (d2 to d3).

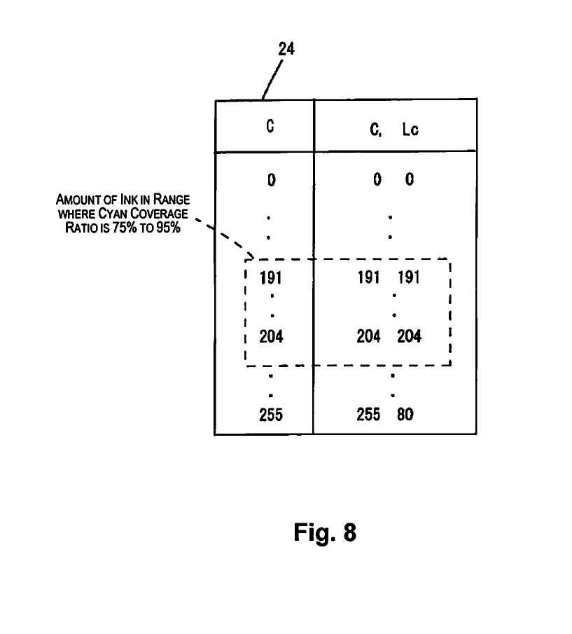

In step S4, the half tone processing section 13c converts the amount of ink which is specified for each of the pixels in the designated image data after the separation process into an amount of ink for the first ink and an amount of ink for the second ink. FIG. 8 is a diagram illustrating a dot conversion table which is used by the half tone processing section 13c in step S4. In a dot conversion table 24, an amount of ink for cyan (C), an amount of ink for cyan (C) as the first ink which is associated with the amount of ink, and an amount of ink for light cyan (Lc) as the second ink are recorded. As a result, the half tone processing section 13c converts the amount of ink for cyan (C) which is specified for the pixels in the designated image data into amounts of ink for cyan (C) and light cyan (Lc) using the dot conversion table 24. Here, in FIG. 8, the amount of ink for cyan (C) which is recorded as the input value in the dot conversion table 24 and the amount of ink for cyan (C) which is recorded as an output value which corresponds to the input value are the same value, but the relationship of the input value and the output value is not limited to being the same value.

In the dot conversion table 24, the relationship characteristics between the first ink (cyan) and the second ink (light cyan) shown in FIG. 4 are specified in a range of a first amount of ink for the first ink (cyan) where it is easy for cockling unevenness to occur. That is, in the relationship characteristics between the first ink and the second ink which are generated by the process in step S4, an amount of ink for the second ink for a countermeasure for cockling unevenness is applied in an amount of ink where the coverage ratio of the first ink is 75 percent to 95 percent. In the illustrated embodiment, the coverage ratio of the first ink is determined according to the amount of ink for the first ink (cyan) which is recorded as the input values in the dot conversion table 24. For example, in the amount of ink (the input value) where the amount of ink for cyan (C) is 80 percent (204 as a gradation value) in the dot conversion table 24 shown in FIG. 8, cyan (C) and light cyan (Lc) are generated in equal amounts with (C, Lc)=(204, 204) as the output value.

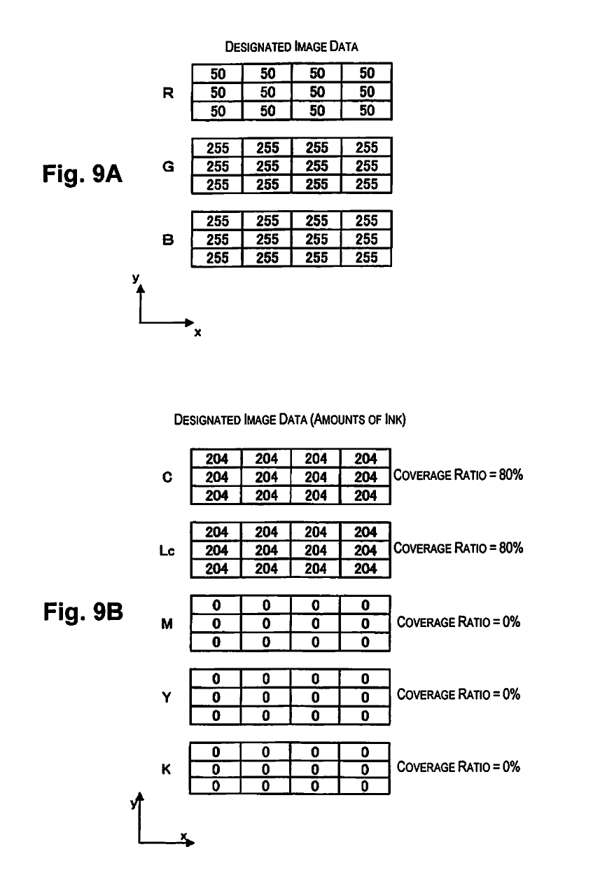

FIGS. 9A and 9B illustrate diagrams explaining the designated image data which is converted using the processes in steps S3 and S4. In FIG. 9A, a portion of the designated image data before the separation process indicates each of the colors of red (R), green (G), and blue (B). In addition, FIG. 9A illustrates 4×3 pixels where the resolution is converted from one pixel where the input values are (R, G, B)=(50, 255, 255) on an axis (referred to below as the W-C axis) which joins the point W and the point C in the gamut CS shown in FIG. 7B. In addition, FIG. 9B illustrates the designated image data (the amounts of ink) which corresponds to each of the pixels shown in FIG. 9A. In FIG. 9B, the gradation values of all of the pixels are 204 (coverage ratio=80 percent) for the amount of ink for cyan (C). In addition, the amount of ink for light cyan (Lc) which is generated along with the cyan (C) according to the process in step S4 is 204 (coverage ratio=80 percent) for all of the pixels. That is, the amounts of ink for cyan (the first ink) and light cyan (the second ink) which express the relationship characteristics in the graph in FIG. 4 are specified in the designated image data (the amount of ink) after conversion in the range of the first amount of ink.

In step S5, the half tone processing section 13c carries out a half tone process with regard to the designated image data after conversion. According to the half tone process, binarized half tone data is generated which specifies the forming of dots (dots on) or the non-forming of dots (dots off) for each of the pixels from data which is continuous from 0 to 255.

Other than binarization, in a case where the printing mode changes the size of the dots, multiplexed half tone dots, which are formed of “large dots”, “medium dots”, and “small dots”, may be formed.

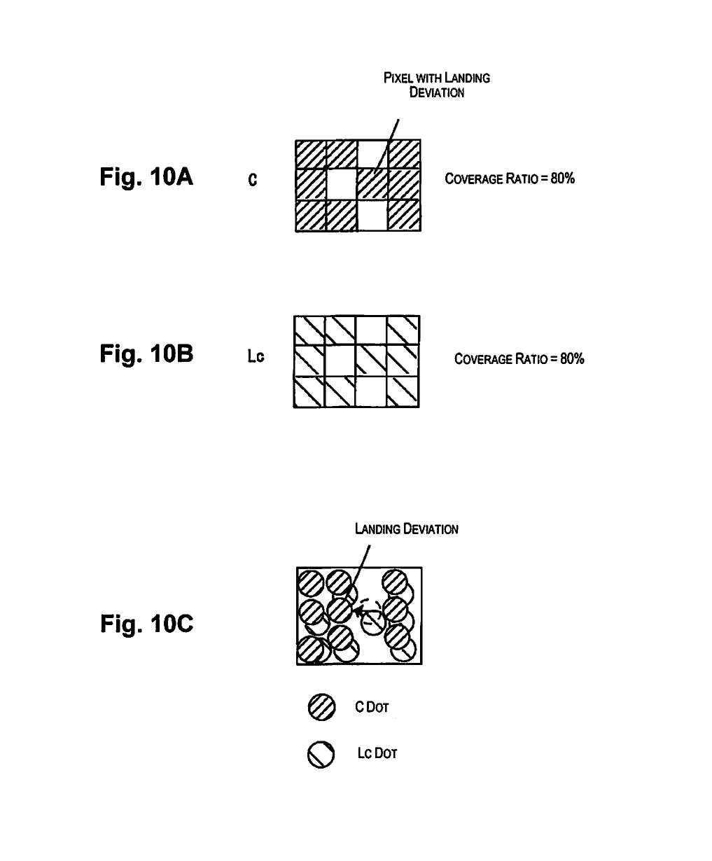

FIGS. 10A, 10B, and 10C illustrate diagrams for explaining dots which are generated in the present application. FIGS. 10A and 10B illustrate half tone data of light cyan (Lc) which is generated based on the 4×3 pixels shown in FIG. 9B. Here, the pixels where hatching is applied in FIGS. 10A and 10B are pixels where the dots are set to ON.

As shown in FIG. 10A, out of the 4×3 pixels, there are 9 pixels (80 percent) where the dots are set to ON in the half tone data since the coverage ratio of cyan (C) is 80 percent. On the other hand, out of the 4×3 pixels in the half tone data, there are 9 pixels (80 percent) where the dots are set to ON since the coverage ratio of light cyan (Lc) is 80 percent. In addition, the pixels where the dots are set to ON in the half tone data of cyan (C) and the half tone data of light cyan (Lc) are formed at positions which are close.

Here, in each of the half tone data for cyan and light cyan in FIGS. 10A and 10B, the half tone data is formed such that each of the dots overlaps. However, the method for arranging the dots is not limited to this and may be a method where a pattern of each of the dots of cyan (C) and light cyan (Lc) is arranged by shifting a number of pixels each time in the x direction (a direction which corresponds to the main scanning direction).

In addition, the specific method of the half tone process which is executed in step S4 is not particularly limited. In the illustrated embodiment, the half tone process is executed using a dither method where a dither mask is used which is stored in advance in the HDD 20 or the like. In addition to this, the half tone process may be executed using an error diffusion method which is known in the art.

The process proceeds to step S6 and the transfer section 13d performs a process where the half tone data is sorted into an order in which the half tone data is to be transferred to the print head 62. According to the sorting process, each of the dots which is specified in the half tone data is sorted according to the pixel positions of the dots and each of the colors of the ink and it is confirmed by which nozzles of which nozzle row of the printer 50 and at what timing each of the dots is to be formed. Due to the transfer section 13d sequentially transmitting raster data (an example of the half tone data) after the sorting process to the printer 50, the printer 50 discharges dots from each of the nozzles. Due to this, an image is reproduced on the print substrate based on the half tone data.

FIG. 10C illustrates dots which are formed according to the half tone data shown in FIGS. 10A and 10B. By the printer 50 forming dots of each of the colors based on the half tone data, dots are formed where the dots of cyan (C) and the dots of light cyan (Lc) are arranged at positions which are close. As a result, even in a case where cockling is generated and landing deviations occur in the dots of cyan (C) in the center, changes in brightness (cockling unevenness) are reduced since this region is covered with dots of light cyan (Lc).

As described above, in the first embodiment, it is possible to reduce an increase in brightness using the dots of the second ink which are formed in the vicinity of the dots of the first ink even in a case where cockling unevenness occurs. In addition, by the increase in the amount of the first ink being large in a range of an amount of ink for the first ink where it is easy for cockling unevenness to occur, the range of the input values which corresponds to the range of the first amount of ink is narrowed compared to other ranges and it is possible to for it to be difficult to select an amount of ink for the first ink where it is easy for cockling unevenness to occur.

In addition, it is possible to perform the countermeasure for cockling unevenness in the present application without significantly damaging the relationship characteristics between the input values and the colors of the dots which reproduce the input values by the second ink being the same color as the first ink.

### 2. Second Embodiment

In a second embodiment, an ink with a high brightness compared to the first ink is used as the second ink, but the second embodiment is different to the first embodiment in the configuration where the first ink and the second ink are not the same color. As a result, in the second embodiment, in a case where the first ink is any of cyan, magenta, and black, the second ink is any of light cyan (Lc), light magenta (Lm), gray (Lk), and yellow (Y). It is obvious that the relationship characteristics between the first ink and the second ink are not limited to this as long as there is a difference in brightness.

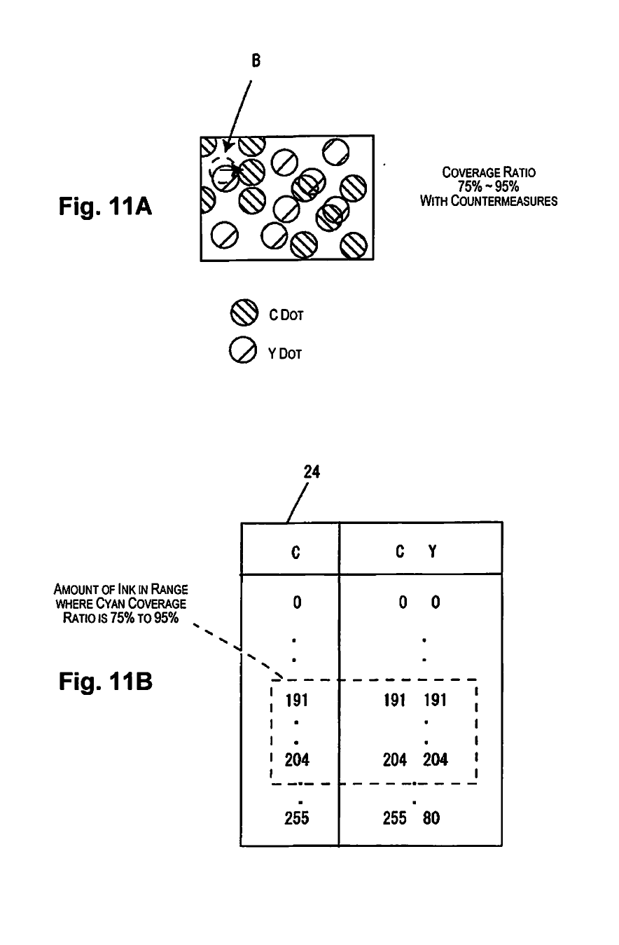

FIGS. 11A and 11B are diagrams explaining a separation process according to the second embodiment. In FIG. 11A, the first ink is cyan (C) and the second ink is yellow (Y). That is, the second embodiment is the same as the first embodiment in the configuration where the dots of the first ink and the dots of the second ink are formed at positions which are close in a range of an amount of ink where the coverage ratio is 75 percent to 90 percent. For example, landing deviations occur in cyan (C) dots in a region B shown by an arrow in FIG. 11A, and yellow (Y) dots are formed in the vicinity. As a result, the yellow (Y) dots suppress an increase in brightness and reduce cockling unevenness.

FIG. 11B is a diagram illustrating the dot conversion table 24 which is used by the half tone processing section 13c. That is, the half tone processing section 13c specifies the amount of ink for the yellow (Y) ink according to the cyan (C) ink by performing conversion using the dot conversion table 24 with regard to the designated image data (the amount of ink) after the separation process shown in step S3 in FIG. 6. Also in the second embodiment, the relationship between the first ink and the second ink has the relationship characteristics shown in FIG. 4. That is, the amount of ink for the first ink (cyan) and the amount of ink for the second ink (yellow) are generated according to the input values in the range (from Im1 to Im2) of the first amount of ink shown in FIG. 4. In addition, the increase in the amount of the first ink (cyan) in the range of the first amount of ink is the highest compared to the other ranges and, as a result, the third range R3, which is the input values which correspond to the range of the first amount of ink, is narrow compared to the ranges (R1 and R2) of the other input values.

Also in the second embodiment, in the single color ink, an amount of ink where it is easy for density unevenness to occur is an amount of ink where the coverage ratio using the dots in the single color is from 75 percent to 95 percent.

Since the dot conversion table 24 has the relationship characteristics shown in FIG. 4, an amount of ink for yellow (Y) is applied in order to carry out a cockling unevenness countermeasure in an amount of ink where the coverage ratio of cyan (the first ink) is 75 percent to 95 percent. For example, in the dot conversion table 24 shown in FIG. 11B, the amount of ink for yellow (Y) is generated in an amount (204) which is equal with regard to the amount of ink (204) of cyan (C) where the coverage ratio (the amount of ink) is set to 80 percent.

In the illustrated embodiment, the amount of ink for yellow (the second ink) which is recorded in the dot conversion table 24 is an amount of ink which is newly generated according to the amount of ink for cyan (the first ink). That is, even in a case where the amount of ink for yellow (Y) is generated from the input values (R, G, and B) according to the separation process in step S3 in FIG. 6, the new amount of ink for yellow (Y) is acquired as the second ink in the process in step S4 in FIG. 6. As a result, the amount of ink for yellow which is set for the pixels in the designated image data is the sum of the amounts of ink which are acquired in the processes in steps S3 and S4.

It is obvious that, in addition to this, the amount of ink for yellow (the second ink) which is recorded in the dot conversion table 24 may include the amount of ink for yellow which is acquired due to the separation process. In this case, the amount of ink for yellow (Y) which is set for the pixels in the designated image data is only the amount of ink for yellow (Y) which is newly acquired in step S4.

As a result, the amounts of ink for cyan (C) and yellow (Y) which express the relationship characteristics in FIG. 4 are selected in a case where the input values correspond to an amount of ink where it is easy for density unevenness to be generated by the separation processing section 13b generating the second ink according to the first ink using the dot conversion table 24.

As described above, by printing the dots of the first ink and the dots of the second ink with a low brightness compared to the first ink at locations which are close in the second embodiment, it is possible for an increase in the brightness (cockling unevenness), which is generated by landing deviations in the first ink which are caused by cockling, to be reduced using the second ink.

Additionally, since the relationship characteristics between the first ink and the second ink are not limited to being the same color, it is possible to flexibly apply combinations of the first ink and the second ink. That is, even in a case where the printing apparatus 100 is only provided with each of the inks of cyan, magenta, yellow, and black, it is possible to deal with density unevenness which is caused by cockling in the present application by the first ink being any of cyan, magenta, or black and the second ink being yellow.

### 3. Various Modified Examples

### Modified Example 1

The countermeasure for cockling unevenness in the present application may be applied only with regard to print substrate where it is easy for cockling to occur. For example, range coated paper (RC paper) is known to have low water absorption. On the other hand, normal paper and cardboard are known to have high water absorption and for it to be easy for cockling to occur compared to range coated paper. As a result, the printing apparatus 100 may use the dot conversion table 24 for a countermeasure for cockling unevenness only in a case of using the print substrate such as cardboard where it is easy for cockling to occur.

By setting the configuration described above, since the cockling countermeasure of the present application is performed only in a case of using the print substrate where it is easy for cockling to occur, it is possible to prioritize the reproducibility of color in other cases.

### Modified Example 2

The process which is performed by the half tone processing section 13c is not limited to a process which uses the dot conversion table 24. For example, the half tone processing section 13c may use calculations to acquire the amount of ink for the second ink according to the amount of ink for the first ink.

In addition, the separation process which is performed by the separation processing section 13b is not limited to a process which uses the color conversion profile. For example, the separation processing section 13b may use calculations to specify the amount of ink according to the input values. In addition to this, the separation process may calculate the desired amount of ink using complementary calculations which are known in the prior art based on the amount of ink which is acquired using the color conversion profile.

Furthermore, the process where the amount of ink for the second ink is acquired according to the amount of ink for the first ink may be a process which is performed by a part other than the half tone processing section 13c.

### Modified Example 3

In addition, the second ink which is set according to the first ink is not limited to being one color. For example, in a case where cyan ink is the first ink, the second ink may be two colors such as light cyan and gray.

### Modified Example 4

The printer 50 may be a line printer. A line printer has a head for a line printer with a long shape as the print head 62. As a result, the print head 62 is fixed at a predetermined position inside the printer 50. In the print head 62, a direction, which crosses (intersects with) the direction (the feed direction) in which the print substrate moves, is the longitudinal direction and the print head 62 is provided with a nozzle row where nozzles of each of the colors are in a row in the longitudinal direction. The nozzle row has a length which corresponds to at least the width of the region where printing is possible on the print substrate out of the width of the print substrate in the longitudinal direction described above. In addition, the nozzle row is provided with each type of ink which is used by the printer 50.

By using the configuration described above, it is also possible to apply the present application in a line printer.

Specific examples of the print substrate which is used in the printer 50 include flat paper, roll paper, paperboard, paper, non-woven fabric, cloth, ivory, asphalt paper, art paper, color paperboard, high quality color paper, ink jet paper, print senka paper, printing paper, printing paper A, printing paper B, printing paper C, printing paper D, India paper, thin sheet printing paper, thin sheet Japanese paper, back carbon paper, airmail paper, sanitary paper, embossed paper, OCR paper, offset paper, thick paper for cards, chemical fiber paper, processing paper, drawing paper, pattern paper, single sided lustrous Kraft paper, wallpaper base, spinning paper, paper string base paper, pressure-sensitive copying paper, photosensitive paper, thermal paper, rice paper, paperboard for cans, yellow paperboard, imitation leather paper, ticket paper, high performance paper, cast coated paper, tissue paper, Japanese vellum, metallized paper, metallic paper, glassine, gravure paper, Kraft paper, extensible kraft paper, kraft board, crepe paper, lightweight coated paper, cable insulating paper, saturating decorative paper, building material base paper, Kent paper, abrasive paper base, synthetic paper, synthetic fiber paper, coated paper, condenser paper, miscellaneous paper, woody paper, bleached kraft paper, diazo photosensitive paper, paper tube base paper, magnetic recording paper, cardboard for paper containers, dictionary paper, light shielding paper, kraft paper for heavy bags, pure white roll paper, security paper, sliding door paper, high quality paper, information paper, food container base paper, book paper, calligraphy paper, white paperboard, white board, newsprint paper, blotting paper, water-soluble paper, drawing paper, ribbed kraft paper, laid paper, speaker cone paper, electrostatic recording paper, sanitary paper, paper cotton paper, laminate base paper, gypsum board base paper, base stock for adhesive paper, semi-quality paper, cement bag paper, ceramic paper, solid fiber board, tar felt paper, tarpaulin paper, alkali-proof paper, fire-resistant paper, acid-proof paper, greaseproof paper, paper towels, Dan paper, cardboard, cardboard base paper, map paper, chip board, medium-quality paper, neutral paper, tissues, mat art paper, tea bag paper, tissue paper, electrical insulating paper, Tengujo tissue, pasting paper, transfer paper, toilet paper, tabulating card stock, mimeograph base paper, coated printing paper, coated paper base paper, Torinoko paper, tracing paper, corrugating medium, napkin base paper, flame-retardant paper, NIP paper, tag paper, adhesive paper, carbonless paper, released paper, brown paper, Baryta paper, paraffin paper, wax paper, vulcanized fiber, Hanshi paper, PPC paper, writing paper, ultra light weight coated paper, form paper, continuous slip paper, copy paper, pressboard, moisture-proof paper, uncreased Japanese paper, waterproof paper, anti-tarnish paper, wrapping paper, bond paper, Manila paper, Mino paper, Shoin paper, milk carton base paper, imitation Japanese vellum, oil paper, Yoshino paper, rice paper, cigarette paper, liner, parchment paper, double-sided kraft paper, roofing paper, filter paper, Japanese paper, varnish paper, mill wrapper, light weight paper, air-dried paper, wet-strength paper, ashless paper, acid free paper, no finish paper or paperboard, two-layer paper or paperboard, three-layer paper or paperboard, multi-layer paper or paperboard, unsized paper, sized paper, wove paper, wood grain paper or paperboard, machine finish paper or paperboard, machine-glazed paper or paperboard, plate-glazed paper or paperboard, friction-glazed paper or paperboard, calendar processed paper or paperboard, super calendar processed paper, ramin (paper or paperboard), one-sided colored paper or paperboard, double-sided colored paper or paperboard, twin wire paper or paperboard, rag paper, all rag paper, mechanical pulp paper or paperboard, mixing straw pulp paper or paperboard, water finish paper or paperboard, chip board, joint chip board, millboard, glazed millboard, homogeneous paperboard, mechanical pulp paperboard, brown mechanical pulp paperboard, brown mixture pulp paperboard, imitation leather paperboard, asbestos paperboard, felt board, tar brown paper, water leaf paper, surface size paper, press pan paper, press paper, finish paper with added wrinkles, laminate Ivory, blade coated paper, roll coated paper, gravure coated paper, sized press coated paper, brush coated paper, air knife coated paper, extrusion coated paper, dip coated paper, curtain coated paper, hot melt coated paper, solvent coated paper, emulsion coated paper, bubble coated paper, imitation art paper, bible paper, poster paper, packaging tissue, base paper, carbon base paper, diazo photosensitive paper base paper, photographic printing base paper, frozen food base paper used as direct contact paper, frozen food base paper used as non-contact paper, safety paper, banknote paper, insulating paper or paperboard, laminate insulation paper, electrical insulating paper for cables, shoe sole paperboard, textile paper tube paper, crest paper or paperboard, paperboard for pressing, paperboard for bookbinding, paperboard for clothing boxes, matrix paper, recording paper, kraft liner, certified liner, kraft tension liner, waste paper liner, envelope paper, paperboard for folding boxes, paperboard for coating folding boxes, paperboard for folding boxes with bleached pulp backing, typewriter paper, mimeograph copy paper, spirit copy paper, calendar roll paper, shell casing paper, corrugated paper, paper for corrugating, two-layered tar paper, strengthened two-layer tar paper, cloth-covered paper or paperboard, cloth core paper or paperboard, reinforced paper or reinforced paperboard, laminated paperboard, carton compact, overlay, pulp molded products, wet crepe, search card, carbon paper, multi-copy form paper, back carbon form paper, carbonless form paper, envelopes, postcards, pictorial postcards, postal letters, pictorial postal letters, and the like. In particular, the high performance paper includes paper which utilizes a wide range of materials such as inorganic, organic, and metal fibers without being limited to plant fibers, where a high performance is given in the paper making and processing steps, and which is primarily used as a material in cutting edge fields such as information, electronics, and medicine, but the paper is not limited to these.

### General Interpretation of Terms

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Finally, terms of degree such as “substantially”, “about” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

While only a selected embodiment has been chosen to illustrate the present invention, it will be apparent to those skilled in the art from this disclosure that various changes and modifications can be made herein without departing from the scope of the invention as defined in the appended claims. Furthermore, the foregoing descriptions of the embodiment according to the present invention are provided for illustration only, and not for the purpose of limiting the invention as defined by the appended claims and their equivalents.

What is claimed is:

1. A printing apparatus configured to discharge ink from a print head, the printing apparatus comprising:
a first processing section configured to convert input values that are specified for each pixel in image data into amounts of ink for inks of each color; and
a second processing section configured to generate half tone data that specifies the presence or absence of half tone dots based on the image data that is converted,
the second processing section being further configured to convert an amount of ink for a first ink, which is in a range of a first amount of ink where it is easy for density unevenness to be generated, into an amount of ink for the first ink and an amount of ink for a second ink that is the same color as the first ink and has a high brightness compared to the first ink,
an increase in the amount of the first ink that is set in the range of the first amount of ink being large compared to an increase in the amount of the first ink in a range of a second amount of ink that is different to the range of the first amount of ink.

2. The printing apparatus according to claim 1, wherein
the range of the first amount of ink is a range that corresponds to an amount of ink where a coverage ratio, which indicates an area covered by ink per unit area, is in a range of 75 percent to 95 percent.

3. The printing apparatus according to claim 1, wherein
the second ink that is set in the range of the first amount of ink is reduced in accordance with an increase in the input values.

4. The printing apparatus according to claim 1, wherein
the second ink is light cyan in a case where the first ink is cyan, the second ink is light magenta in a case where the first ink is magenta, and the second ink is gray in a case where the first ink is black.

5. A printing method, in which half tone dots are printed by discharging ink from a print head, the method comprising:
converting values of a predetermined color space that are specified for each pixel of image data into amounts of ink for each color; and
generating half tone data that specifies the presence or absence of half tone dots that are to be printed by the print head based on the image data that is converted,
the converting of the values of the predetermined color space including converting an amount of ink for a first ink, which is in a range of a first amount of ink where it is easy for density unevenness to be generated, into an amount of ink for the first ink and an amount of ink for a second ink that is the same color as the first ink and has a high brightness compared to the first ink,
an increase in the amount of the first ink that is set in the range of the first amount of ink being large compared to an increase in the amount of the first ink in a range of a second amount of ink that is different to the range of the first amount of ink.
